(19) United States
(12) Patent Application Publication
(10) Pub. No.: US 2025/0086176 A1
(43) Pub. Date: Mar. 13, 2025

(54) COMPILING JUST THE BEST BITS: FINDING THE MAXIMUM BENEFIT SHARED SUBEXPRESSIONS IN A QUERY WORKLOAD

(71) Applicant: Oracle International Corporation, Redwood Shores, CA (US)

(72) Inventors: Lawrence Lim, Santa Clara, CA (US); Laleh Aghababaie Beni, Pasadena, CA (US); Garret F. Swart, Palo Alto, CA (US)

(21) Appl. No.: 18/638,931

(22) Filed: Apr. 18, 2024

Related U.S. Application Data
(60) Provisional application No. 63/537,446, filed on Sep. 8, 2023.

(51) Int. Cl. G06F 16/2453; G06F 11/34; G06F 16/2452

(52) U.S. Cl. CPC G06F 16/24542; G06F 11/3419; G06F 16/24524

(57) ABSTRACT

In a computer, each of many statement plan trees respectively represents a distinct database statement in a database workload. Each statement plan tree contains a distinct set of tree nodes. A first statement plan tree contains a first subtree and represents a first statement. A second statement plan tree contains a second subtree, and a third statement plan tree contains a third subtree. By agglomeration, a first cluster subplan is generated that represents the first subtree of the first statement plan tree and the second subtree of the second statement plan tree. By subsequent agglomeration, a second cluster subplan is generated that represents the third subtree of the third statement plan tree and the first cluster subplan. Execution of the first database statement uses the second cluster subplan for acceleration. Agglomeration may be decided based on novel net benefit estimation, novel inter-cluster distance, and a novel and tunable compilation cost.

### BENEFIT CLAIM

This application claims the benefit under 35 U.S.C. § 119(c) of provisional application 63/537,446, filed Sep. 8, 2023, by Lawrence Lim et al., the entire contents of which is hereby incorporated by reference. The applicant hereby rescinds any disclaimer of claim scope in the parent applications or the prosecution history thereof and advise the USPTO that the claims in this application may be broader than any claim in the parent application.

### FIELD OF THE DISCLOSURE

This disclosure relates to database statement acceleration by compilation. For partially overlapping statements, herein is compilation of reusable portions that are optimally selected by novel cost-benefit estimation.

### BACKGROUND

Since relational database implementations have shifted from disk-based to in-memory, central processing unit (CPU) time consumption has become a primary bottleneck to improving database performance. One way to decrease CPU processing time is by compiling a structured query language (SQL) plan into native machine code that consists of instructions of an instruction set architecture of a processor. A natively compiled query can be more efficiently executed than a direct interpretation of the query because (a) native code can avoid spending compute cycles interpreting the query plan and (b) compiler optimizations can further minimize operations during query execution.

Unfortunately, natively compiling a query has significant costs in (i) producing the binary, (ii) loading the binary into the database system's in-memory text (i.e. code) segment, and (iii) additional load on hardware that caches instructions. Due to these costs, many database systems such as online transactional processing (OLTP) systems, may entirely avoid native compilation. In particular, OLTP systems need to execute a large number of simple queries with low latency, and the latency of just-in-time (JIT) generating a binary may be too expensive. Instead, such systems may opt for well-tuned pre-compiled queries. On the other hand, online analytical processing (OLAP) queries require significant CPU resources to compute a query, so the performance improvement from compiler optimizations are greater than the costs of native compilation. To apply native compilation more broadly (beyond OLAP queries), either the costs of native compilation would need to be decreased (such as through pre-compilation) or its benefits increased. Herein, binary and executable may be synonyms for object code in some contexts.

The state of the art has yet to explore compiling and reusing common portions of query plans. For a given computer resource budget such as compilation time or in-memory text segment space, the state of the art does not maximize workload acceleration, which cannot be achieved by compiling whole queries.

### BRIEF DESCRIPTION OF THE DRAWINGS

In the drawings:

FIG. 1 is a block diagram that depicts an example computer that compiles, to an instruction set architecture (ISA) of a processor and for partially overlapping database statements, reusable portions that are optimally selected by novel cost-benefit estimation;

FIG. 2 (consisting of FIGS. 2A and 2B) is a dataflow diagram that depicts an example computer that compiles, to an ISA of a processor and for partially overlapping database statements, reusable portions that are optimally selected by novel cost-benefit estimation;

FIG. 3 is a flow diagram that depicts an example computer process that accelerates execution of a database statement by decomposing optimized query plan into a mix of compiled and uncompiled subplans;

FIG. 4 is a block diagram that depicts an example computer that can generate various plans and subplans for a query;

FIG. 5 is a dataflow diagram that depicts example subplan clustering that iteratively generates subplans from statement plan trees for respective database statements in a workload;

FIG. 6 is a flow diagram that depicts an example computer process that accelerates execution of a database statement by decomposing its statement plan tree into a mix of compiled and uncompiled subplans;

FIG. 7 is a block diagram that depicts example subplan clustering that can generate various plans and subplans for a query that is represented by a query plan during either or both code generation and execution phases;

FIG. 8 is a flow diagram that depicts an example computer process that accelerates execution of a database statement by decomposing its optimized query plan into a mix of compiled and uncompiled subplans;

FIG. 9 is a block diagram that illustrates a computer system upon which an embodiment of the invention may be implemented;

FIG. 10 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Here is a new way to minimize native compilation costs by natively compiling the portions of query plans that are commonly executed and provide the greatest performance improvement. Compiling queries into native code can improve relational database performance despite significant compilation overhead. Compilation costs should be balanced with compilation benefits such as faster query executions and the ability to reuse optimized native code for the same or similar queries, in which case, costs are amortizable. One way to better manage costs of compilation is by only compiling portions of query executions that provide the most performance benefit from general purpose compiler optimizations while increasing reusability. These portions of query executions are subexpressions of a query that may be reused across multiple different queries. Herein is an algorithm to find the best portions of query plans to compile to maximize performance benefit. A key idea is that similar queries can have similar query plans, so compiling to a reusable binary can save compilation time and leverage some of the benefits of query compilation. This algorithm selects portions of query plans to compile when either (1) an expensive query plan can benefit the most from general purpose compiler optimizations or (2) the machine code can be reused multiple times, amortizing the costs of compilation.

An embodiment may have an offline algorithm that accepts a set of query plans and determines a set of subplans that maximizes the benefit of compilation for a given resource constraint that is tunable. Regardless of embodiment, this approach entails: 1) using unification theory to find common subplans in query plans, 2) developing a model for the performance benefit of natively compiling subplans, and 3) designing algorithms for picking the best subplans that maximize performance benefit when natively compiled.

Herein are novel algorithms to detect query subexpressions which provide the most performance benefit. To that end, these algorithms estimate a performance benefit of compiling a subexpression. Herein, finding common subexpressions is referred to as unification, which may be based on a clustering algorithm to determine the most beneficial subexpressions. Experimental evidence has validated these algorithms with an experimental query engine to compare performance of interpreted, compiled, and partially compiled queries. Partial compilation decisions were experimentally validated based on performance benefit estimation and the clustering algorithm. Partial compilation empirically provided improvement over the other strategies.

A database workload may consist of many database statements, and a portion of one statement may be more or less identical to a portion in another statement. A subplan may be generated to represent similar portions of multiple statements. A shared subplan may have parameters that receive different values as arguments from different statements that share the subplan.

For a workload, many subplans may be generated and their cost-benefits of compilation may be estimated so that only sufficiently beneficial or better ranking compilations occur. For example, a resource budget may limit how much random access memory (RAM) is available to store compiled subplans or how much processor time is spent compiling subplans. Herein are innovative cost-benefit estimations that maximize how much acceleration is achieved by selective compilation of subplans, with or without a resource budget. Some estimations may be based on individual database operators in a subplan and/or statistics of the workload and database content.

Instead of interpreting a whole query plan or executing a compiled whole query plan, an evaluation plan herein is a novel database component that may be generated that contains a mix of compiled and uncompiled subplans. In that way, query execution may entail switching back and forth between subplan interpretation and, for acceleration, direct execution of a machine instruction sequence of a compiled subplan. For a given resource budget, this approach provides more acceleration of a workload than possible by the state of the art. Herein is a novel compilation cost constant that is tunable to discover a best tradeoff between query acceleration and resource consumption before or during query execution. One compilation of one parameterized subplan herein may accelerate multiple distinct queries that share the subplan, and this is a novel acceleration.

This shared compiled subplan is so behaviorally flexible that it can accept multiple parameters, including unspecialized parameters that may identify other compiled and uncompiled subplans. Herein are a code generation phase that may compile many shareable subplans, and a subsequent execution phase that may contextually select a subset of the compiled subplans to combine into a dynamically generated evaluation plan that may or may not also contain uncompiled (i.e. interpreted) subplans. For example, a new query that did not exist in the workload of the code generation phase may nonetheless use compiled subplans, which achieves somewhat future-proofed query acceleration.

### 1.0 Example Computer

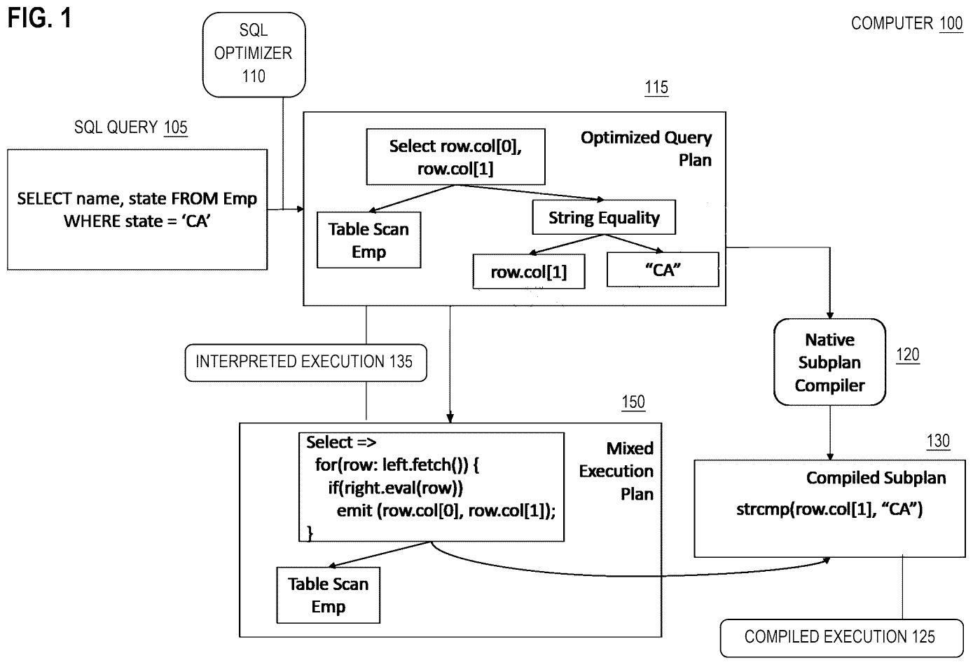

FIG. 1 is a block diagram that depicts example computer 100 that compiles, to an instruction set architecture (ISA) of a processor and for partially overlapping database statements, reusable portions that are optimally selected by novel cost-benefit estimation. Computer 100 may be one or more instances of a rack server such as a blade, a mainframe, a virtual machine, or other computing device.

### 1.1 Workload Lifecycle

Techniques herein are biphasic with statement plan code generation followed by statement execution, with each phase occurring on a same or separate computers. In an embodiment, the statement execution phase occurs on a computer that contains a database server (not shown) that may be a software program that may operate as a (e.g. relational) database management system (DBMS) to administer and operate one or more databases on behalf of one or more database tenants. For example, computer 100 may receive and execute database statements from database clients, such a structured query language (SQL) statements, such as SQL query 105.

In an embodiment, computer 100 is two computers, which is a statement plan code generation computer and a statement execution computer. In another embodiment, a single computer performs both phases. In an embodiment, only the execution phase occurs online with a live workload mix of (e.g. prepared and/or dynamically generated) statements. Herein, a statement is a database statement that consists of text such as data query language (DQL), data manipulation language (DML), data definition language (DDL), or data control language (DCL).

In an embodiment, the code generation phase occurs offline without database clients. For example, the code generation phase may process statements that were previously generated and/or previously executed and logged, and these statements may be archival. Herein, a workload is a mix of (e.g. partially semantically overlapping) statements that may or may not have already executed. Herein, statements overlap if they contain an identical portion that logically contains, for example, one or more lexical tokens or one or more parse nodes as discussed later herein. For example, computer 100 may contain a lexer, a tokenizer, and/or a parser that can, for example, generate a composite representation of a whole or partial statement such as a parse tree, an abstract syntax tree (AST), or a token sequence.

### 1.2 Query Plan Tree and Tree Nodes

For example, optimized query plan 115 may be a logical tree that, as shown, contains five tree nodes (a.k.a. parse nodes) that are interconnected by edges. Although edges are shown as arrows, herein edges are treated as undirected, even though optimized query plan 115 may be, in some embodiments, a directed acyclic graph (DAG). An edge may be implemented as a reference to a tree node, such as a memory address pointer or as an offset into an array of tree nodes or an array of bytes. For example, the five tree nodes may be contiguously or non-contiguously stored in an array or in a dynamically fragmented heap.

As shown, the Select tree node is the root node of optimized query plan 115. A tree node may have zero or more child nodes. For example, the Select root node has two child nodes that are a Table Scan node and a String Equality node. An intermediate node is both a parent node and a child node, such as the String Equality node. A leaf node lacks child nodes, such as the row.col[1] node and the “CA” node. Only the root node is not a child node. As discussed later herein, a parent node may contain a reference to a child node and, during the execution phase, data flows from a child node to a parent node.

### 1.3 Subtree is Subplan

Optimized query plan 115 may be logically composed of subtrees. A subtree contains one or more tree nodes that are hierarchically connected by edges. A subtree contains one node that is the root of the subtree. For example, the String Equality node is the root of a subtree that also contains the row.col[1] node and the “CA” node.

All nodes in a subtree are (e.g. recursively) reachable by edge(s) from the root of the subtree, excluding the edge that connects the root of the subtree to a parent tree node that is not in the subtree. According to that reachability, an exhaustive subtree contains all reachable leaf nodes, and a non-exhaustive subtree does not. For example, a subtree may consist of a) only the Select root node or b) all tree nodes in optimized query plan 115 except the Table Scan node. A subtree may contain zero or more smaller (i.e. fewer nodes) subtrees.

### 1.4 Statement Plan Generation

Optimized query plan 115 may be archival or may be generated by SQL optimizer 110 that is a statement planner. For example for SQL query 105, SQL optimizer 110 may generate multiple statement plans that are distinct but logically equivalent. Logically equivalent plans can be executed to achieve a same logically equivalent execution result, but each plan achieves the result in a distinct way. Logical equivalence of results may or may not require identical results. For example by default, SQL result rows are unordered, and equivalent plans may generate different orderings.

SQL optimizer 110 may select and provide optimized query plan 115 as a best plan that is predicted to, for example, execute fastest. Components 120, 125, 130, 135, and 150 are based on or use only the best plan for SQL query 105, which is optimized query plan 115. Components 120, 125, 130, 135, and 150 preserve database optimizations present in optimized query plan 115, such as relational join ordering in a multijoin.

Herein, optimized query plan 115 may be decomposed into various subplan(s) to be referenced by mixed execution plan 150 that is logically equivalent to optimized query plan 115. As shown, the Select operator is the root node of optimized query plan 115, and the left and right child subtrees of the Select operator are separately represented. In this example, the String Equality operator is the root not of the right subtree that is separately represented as compiled subplan 130 and, as discussed later herein, the remainder of optimized query plan 115 is instead represented by mixed execution plan 150. As discussed later herein, execution of components 130 and 150 occur separately by respective executions 125 and 135, with compiled execution 125 accelerated.

### 1.5 Plan Interpretation

During the execution phase, execution of SQL query 105 occurs by query execution of optimized query plan 115, which may be implemented by either of execution 125 or 135 that may be mutually exclusive alternatives for the entire optimized query plan 115 or, as follows and as shown, may be a mix of compiled and interpreted partial executions for various subtrees in optimized query plan 115. Although it does not logically matter which of logically-equivalent executions 125 and 135 occurs for SQL query 105, interpreted execution 135 is slower as follows.

Interpreted execution 135 directly uses optimized query plan 115 entirely or partially as shown in mixed execution plan 150. For example, the Select node (also referred to as a projection node) in optimized query plan 115 may contain a reference to logic demonstratively shown in the root node of mixed execution plan 150. The Select node may be interpreted by executing that logic.

Interpreted execution 135 may be slow because each tree node in optimized query plan 115 is a fully encapsulated database operator that is interpreted by itself and without knowledge of its parent node or child nodes. Encapsulation may operate as a barrier through which only data content may flow during execution. However, that encapsulation also limits compilation as follows.

Each tree node may contain a reference to a database operator that is already compiled for universal reusability such that the database operator can be referenced and interpreted in any statement plan. Here, universal reusability means that compilation of the database operator has no knowledge about which plans will reference it and, thus, the database operator cannot be optimized for a particular context or particular data.

Interpretation of a database operator, in a query plan of a database statement for a database of a DBMS, does not entail compilation nor code generation, because the database operator necessarily was compiled: a) before the query plan and the database statement existed, b) without accessing or referencing any query plan, c) without operating the database nor the DBMS, and d) without a database client. Interpretation of a database operator requires ahead-of-time (AOT) compilation of the database operator that occurs before any process of the DBMS starts. Interpretation of database operator occurs without accessing source logic of the database operator. That is, a database operator is used for interpretation only as object code consisting of sequence(s) of machine instructions as discussed later herein. An interpretable database operator is built in (i.e. already built into the codebase of a DBMS) and in a final format that is ready to use as is (i.e. without further transformation such as compilation).

Operator encapsulation for universal reusability is based on polymorphism that provides a loose coupling between a parent node and a child node. For example in mixed execution plan 150, interpretation of the root node may cause interpretation of its left child node (i.e. Table Scan node) by invoking the shown left.fetch( ) that does not depend on what kind of tree node is the left child node. In the root node, ‘left’ may be a reference to the Table Scan node, and ‘right’ may be a reference to compiled subplan 130. Components 130 and 150 are discussed in more detail later herein.

Because the left child node is polymorphic, the root node can invoke fetch( ) on the left child node without knowing exactly which kind of child node is the left child node. For example, the root node can invoke left.fetch( ) regardless of whether a) the left child node is a Table Scan node that accesses a database table or b) the left child node is not a table scan node and instead may be an index scan node that does not access a database table or may be a relational join node. For example, each reusable database operator may be implemented as a distinct class in an object oriented language such as C++, and fetch( ) may be a method (i.e. subroutine) that some or all operator classes implement in a polymorphic way such as a C++ virtual function.

### 1.6 Plan Compilation

In that way, interpretation provides universal reusability of database operators. However, interpretation is slow, especially because database operator encapsulation prevents compiler optimizations from being applied anywhere except inside a single operator. Thus, general purpose compiler optimizations such as partial evaluation of parameters, inlining of subroutines and constants, loop unrolling, constant folding, and dead code elimination cannot be applied if information about multiple operators is needed.

For example during interpretation, data flowing along an edge upwards from a child node to a parent node may or may not need datatype conversion, which cannot be decided without knowledge about both of the parent node and the child node, which encapsulation does not provide. Likewise, an interpreted operator is universally reusable for any database schema. For example, a table scan operator is reusable for different database tables.

Likewise in optimized query plan 115, whether the row.col[1] node refers to a table column that contains fixed-length or variable-length strings, and whether that column can or cannot contain null values, depends on the database schema. Thus, interpretation cannot use dead code elimination to omit a check for null values, because the interpretable operator must be ready to be applied to a column that does not contain nulls in one plan and applied by reuse to another column that instead does contain nulls in a same or different plan.

However, native subplan compiler 120 may use all of those various optimizations when generating a compiled version of optimized query plan 115 for compiled execution 125 that is faster than interpreted execution 135. Compiled execution 125 uses a compiled version of all or part of optimized query plan 115, and the compiled version is optimized based on information about multiple tree nodes and the database schema. For example as shown, the logic in compiled subplan 130 identifies (i.e. expressly references) col[1] (i.e. the state column in the Emp table identified in SQL query 105), which cannot be identified during compilation of a database operator for interpreted execution 135. Also as shown, the String Equality operator and its two child operators in optimized query plan 115 are fused (i.e. inlined) into a single expression in compiled subplan 130. Operators fusion cannot occur with database operators processed by interpreted execution 135.

SQL optimizer 110 may contain a SQL parser and/or a SQL grammar. Native subplan compiler 120 does not contain a SQL parser nor a SQL grammar, because native subplan compiler 120 accepts, as input, optimized query plan 115 that is not SQL and may, for example, be proprietary.

### 1.7 Subplan Compilation

As discussed later herein, workload compilation analyzes a whole statement and may or may not compile portions or the entirety of the statement. For example according to net benefit later herein, some statements may be excluded from compilation. For example, it may be infeasible according to a compile-phase time budget or an execution-phase in-memory text segment budget to compile every whole statement in the workload. For example, using too much RAM to store compiled plans may thrash a hardware cache or excessively swap virtual memory, both of which decelerate workload execution.

Likewise, it may be infeasible to compile even a part of every statement in the workload. For example if given a computer resource budget such as compilation time or text segment space, this approach identifies an optimal subset of subplans in statement plans of a workload, which maximizes an estimated net benefit without exceeding the budget. Later herein is identification of an optimal subset of statement subplans without an explicit budget. That is, costs, benefits, and cost-benefit estimation herein do not require a budget, and compilation time and/or text segment space may be conserved even without a budget.

### 2.0 Example Code Generation Phase

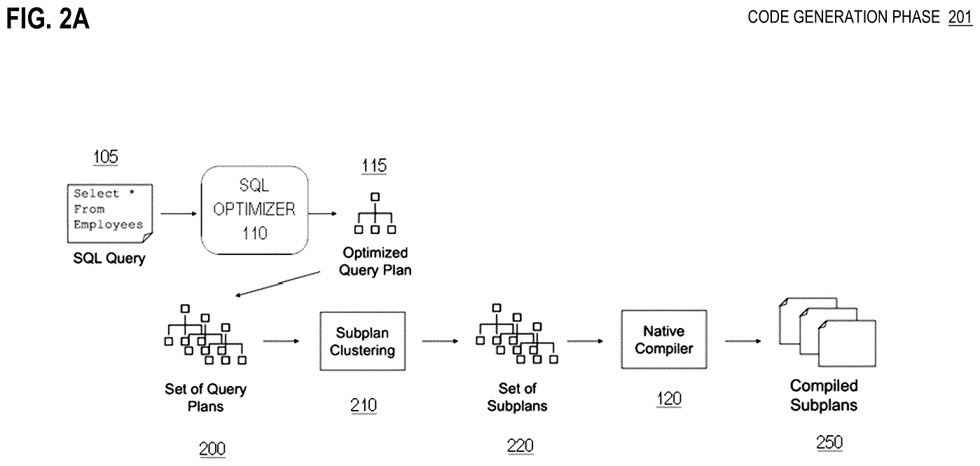

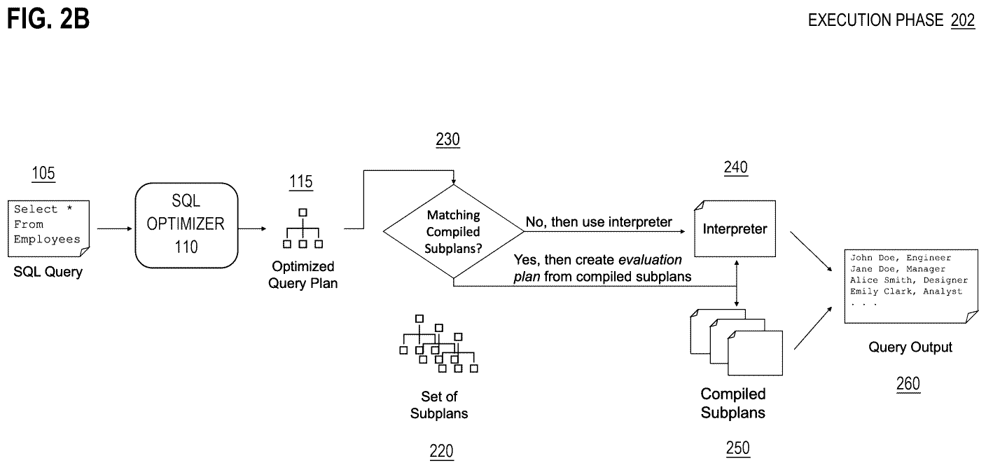

FIG. 2A is a dataflow diagram that depicts example code generation phase 201 that compiles, to an instruction set architecture (ISA) of a processor and for partially overlapping database statements, reusable portions that are optimally selected by novel cost-benefit estimation. Components 120, 200, and 210 operate only during code generation phase 201. Components 105, 110, 115, and 220 may operate during both code generation and execution phases.

Code generation phase 201 occurs as follows. SQL query 105 is one of many database statements (not shown) in a workload as discussed earlier herein. SQL optimizer 110 generates a respective best optimized query plan for each statement in the workload to generate set of query plans 200. Herein, the workload is synonymous with set of query plans 200. The arrows in FIG. 2 indicate dataflow from one component to another in FIG. 2, in which dataflow generally occurs from left to right. For example, components 110, 210, and 120 may respectively be three distinct software stages in a workload compilation pipeline in computer 100.

As discussed later herein, subplan clustering 210 is a mechanism for generalizing somewhat similar subplans, and this mechanism has multiple innovations, some of which provide novel cost-benefit estimation that selects set of subplans 220 from set of query plans 200. Each subplan in set of subplans 220 is reusable and is a) an exact portion or entirety of one or more plans in set of query plans 200 or b) a synthesized subplan that is a parameterized generalization of multiple somewhat similar subplans in one or more plans. A parameterized generalization represents overlapping portions of one or more plans as discussed later herein. Each subplan is a subtree in plan(s) that are tree(s) as discussed earlier herein.

Thus, optimized query plan 115 may be decomposed into multiple subtrees, and zero or more of those subtrees may be retained in set of subplans 220. Thus, set of subplans 220 can be reused to represent none, some, or all of optimized query plan 115. Likewise, many (e.g. most) of the subplans in set of subplans 220 may not represent any part of optimized query plan 115 and may instead represent parts of other plans in set of query plans 200. Set of query plans 200 may contain some plans that are not represented by any of set of subplans 220.

All of set of subplans 220 can be compiled by native compiler 120 that is synonymously shown as native subplan compiler 120 in FIG. 1. Native compiler 120 generates a respective one of compiled subplans 250 for each of one of set of subplans 220. Herein, native compiler 120 may be referred to as a subplan compiler, which is innovative. Although a compiled subplan is logically equivalent to the uncompiled subplan from which it is generated, execution of the uncompiled subplan occurs by interpretation that, as explained earlier herein, is slower than execution of the compiled subplan that does not entail interpretation.

In an embodiment, native compiler 120 itself is a software pipeline having a sequence of stages that are a frontend followed by a backend. In an embodiment, the frontend generates and parses source logic expressed as a source text of a high-level general-purpose programming language such as C/C++ or Java. In an accelerated embodiment that does not generate and parse source text, the frontend instead directly generates a parse tree such as an abstract syntax tree (AST) that a high-level language (HLL) compiler can internally use.

In any case, the frontend contains a general purpose partial evaluator that accepts the AST as input and transforms the AST, by partial evaluation as discussed earlier herein, which generates a logically-equivalent specialized AST that executes faster than the original AST. The backend is a code generator that accepts the specialized AST as input and generates highly optimized object code that can be directly executed by a processor such as a central processing unit (CPU), an execution core of a CPU, or a graphics processing unit (GPU).

The intensity of general purpose optimization of the specialized AST of a subplan is unprecedented, and the object code of the subplan executes with unprecedented acceleration. Whereas, state of the art query compilation cannot decompose a plan into subplans nor extract a subplan from a plan. In other words, compiled subplans 250 is innovative. This distinction between compilation of whole plans versus subplans provides additional budgetary improvements discussed later herein.

Herein, object code contains sequence(s) of machine instructions of an instruction set architecture (ISA) of the underlying native (e.g. hardware or virtual) processor in computer 100. In an embodiment, computer 100 can directly execute object code. In an embodiment, object code is (e.g. Java) bytecode that can be further compiled when executed.

Subplans 220 and 250 are the final result of code generation phase 201, and subplans 220 and 250 may be deployed (e.g. copied) into the execution phase of a same or different computer that supports the ISA of the object code (i.e. compiled subplans 250). In the execution phase, compiled subplans 250 selectively execute, but set of subplans 220 do not execute and are used only referentially for matching to compiled subplans 250 as discussed later herein.

As discussed earlier herein, a subplan may be generalized with parameters to represent multiple distinct actual subplans. Herein, a parameterized generalized subplan may be referred to as a cluster of similar subplans. As discussed later herein, matching is a special analysis that detects whether or not a given subplan is sufficiently similar to the subplans in a cluster. In code generation phase 201 as further discussed later herein, matching is performed by subplan clustering 210.

In code generation phase 201, matching decides: a) whether two actual subplans are similar enough to generate a new cluster, b) whether an actual subplan is similar enough to join (i.e. become a member of) a cluster, and c) whether two clusters can be combined to generate a more generalized cluster. Mechanisms of matching are discussed later herein. In an embodiment, set of subplans 220 consists only of clusters (i.e. parameterized generalized subplans), which can be deployed into the execution phase without the actual subplans from which the clusters were generated.

### 2.1 Example Workload Lifecycle

FIG. 2B is a dataflow diagram that depicts example execution phase 202 that executes SQL query 105 to generate query output 260. Query output 260 exists only during execution phase 202, and components 230, 240, and 250 operate only during execution phase 202. Components 105, 110, 115, and 220 may be used during both code generation and execution phases.

As discussed earlier herein, a subplan may be generalized with parameters to represent multiple distinct actual subplans. Herein, a parameterized generalized subplan may be referred to as a cluster of similar subplans. Matching is a special analysis that detects whether or not a given uncompiled subplan is sufficiently similar to a compiled subplan. In execution phase 202, matching is performed by matching compiled subplans 230.

In execution phase 202, matching only decides whether an actual subplan in a currently pending plan (e.g. 115) can be executed by executing one or more of compiled subplans 250. In execution phase 202, matching entails detecting that a subplan in set of subplans 220 is a generalization of a pending actual subplan. Herein, pending means awaiting execution.

In execution phase 202, computer 100 uses a bijective (i.e. one-to-one) mapping (not shown) between subplans 220 and 250, and the mapping was generated by code generation phase 201. Thus, matching compiled subplans 230 may use any actual subplan as a lookup key into the mapping to retrieve one of compiled subplans 250 that can, for acceleration, be executed instead of slowly interpreting the actual subplan by interpreter 240.

Execution phase 202 can decompose a pending actual plan into multiple subplans, and matching compiled subplans 230 detects which actual subplans match which compiled subplans. For example, a pending plan may be decomposed into a mix of compiled and uncompiled (i.e. interpreted) subplans. For example for optimized query plan 115, a mix of subplans is assembled into a composite plan, which FIG. 2B refers to as an evaluation plan that is shown in FIG. 1 as mixed execution plan 150, that is logically equivalent to uncompiled optimized query plan 115 that, if entirely interpreted, is slower than mixed execution plan 150 that is partially or entirely compiled. Thus for acceleration not possible by only interpretation, a single execution of SQL query 105 may switch back and forth between executing compiled subplans and interpreting uncompiled subplans. Mechanisms of invoking a compiled or uncompiled subplan are discussed later herein. Herein, an evaluation plan and a mixed execution plan are synonymous.

### 3.0 Example Plan Lifecycle

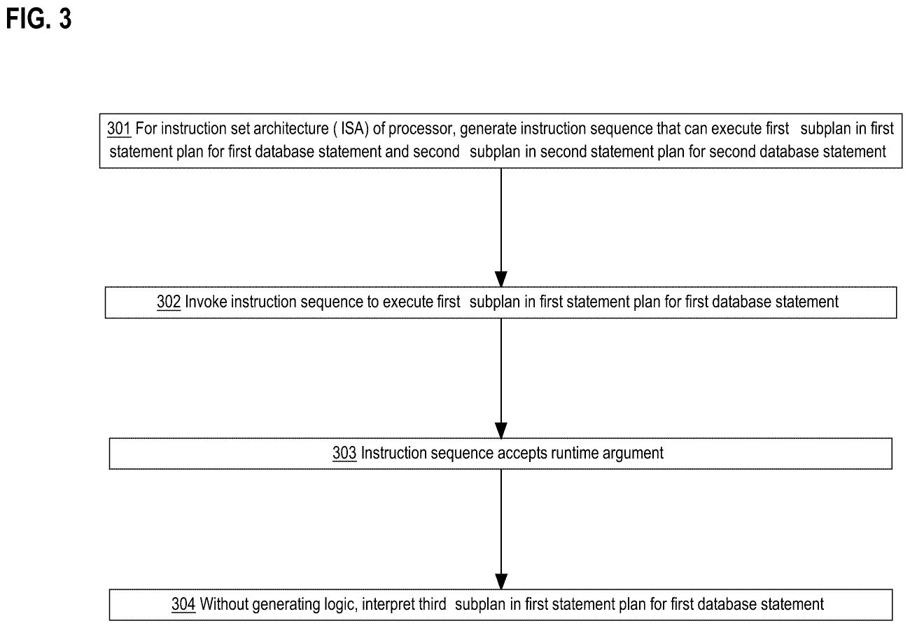

FIG. 3 is a flow diagram that depicts an example process that computer 100 may perform to accelerate execution of database statement 105 by decomposing optimized query plan 115 into a mix of compiled and uncompiled subplans. Step 301 occurs during code generation phase 201. Steps 302-304 occur during execution phase 202 on a same or different computer. In code generation phase 201 but before step 301, subplan clustering 210 generates clusters as discussed elsewhere herein, and the clusters are retained for both phases 201-202, including for all of the process of FIG. 3.

For an instruction set architecture (ISA) of a processor, step 301 generates an instruction sequence (i.e. object code) for a cluster. The cluster and its instruction sequence are parameterized and generalized so that the instruction sequence can be used to execute a first subplan in a first statement plan for database statement 105 and a second subplan in a second statement plan for a second database statement, even though the first and second subplans originally were distinct subplans that, for example, were used to generate the cluster.

Even though the first and second subplans match the cluster in execution phase 202, there is no requirement that the first or second subplan existed during code generation phase 201. That is, a parameterized cluster can match more distinct subplans than were used to generate the cluster. Likewise, parameterized object code of a parameterized cluster can be used for accelerated execution of more distinct subplans than were used to generate the cluster. This flexible matching somewhat future proofs a cluster and its object code to accommodate schemas and statements that do not yet exist. Parameters are discussed below.

In this example, there are three subplans in statement plans for statements, and each subplan is contained in exactly one of two statement plans for two database statements as follows. The three subplans are a first subplan, a second subplan, and a third subplan. Database statement 105 is a first database statement that contains at least two subplans, including the first subplan and the third subplan. The second database statement contains at least one subplan, including the second subplan. In this example and as discussed elsewhere herein, step 301 detects that the first subplan in a first statement plan for database statement 105 and the second subplan in a second statement plan for the second database statement match and should become members in a same cluster that is a parameterized generalization of at least the first and second subplans.

As discussed earlier herein, the frontend and backend of native compiler 120 operate in step 301. The backend is a code generator that accepts as input the specialized AST generated by the frontend as a parameterized and generalized representation of the cluster. This input causes the backend to generate a sequence of highly optimized machine instructions that will be accelerated by direct execution by a processor, which will not entail interpretation (i.e. interpreted execution) of the cluster nor interpretation of the first subplan of the first statement plan for database statement 105.

Step 302 invokes the machine instruction sequence (i.e. one of compiled subplans 250) to accelerated execute the first subplan in the first statement plan for database statement 105. Both of the machine instruction sequence and the cluster that it implements are parameterized and generalized, and both of the machine instruction sequence and the cluster have the same parameter(s).

A cluster may have zero or more parameters. A cluster that lacks parameters also is a cluster that lacks generalization. However, one of compiled subplans 250 that lacks parameters still provides novel acceleration herein because that compiled subplan still is reusable for invocations of multiple distinct statements and/or repeated invocations of a same statement. For example, an unparameterized cluster that contains only one actual subplan as a member during code generation phase 201 may accelerate repeated invocations of the statement that has that actual subplan and, as discussed earlier herein, object code of a parameterized or unparameterized cluster can be used for accelerated execution of more distinct subplans than were used to generate the cluster.

If all actual subplans that are members of a cluster are identical subplans from distinct statement(s), then the cluster and its object code are unparameterized. Otherwise, the cluster is parameterized. One statement may contain multiple identical or similar (i.e. nearly identical) actual subplans that are members of a same cluster that is parameterized if the member subplans are not identical.

In this example, the cluster and object code, as shared by the first and second subplans, are parameterized. In that case in step 303, the machine instruction sequence accepts a (e.g. dynamic, computed, queried, or constant) value as a runtime argument for a parameter of the cluster and object code.

Herein, a runtime argument is a constant that has a same datatype as the parameter expects, which may be a primitive datatype (e.g. number, text string, or Boolean) or an identifier. An identifier may be a pointer (i.e. memory address), array offset, or handle. The identifier may operate as a reference to: a) a database schema element such as a table, a column, or an index or b) a compiled or uncompiled subplan. For example, an identifier of a compiled subplan may be a pointer to its object code. Likewise, an identifier of an uncompiled subplan may be a pointer to the uncompiled subplan, which may be a pointer to the root node of the uncompiled subplan. Likewise, an identifier of a database schema element may be a pointer to a metadata structure that describes the element.

As discussed earlier herein, an uncompiled subplan may be a subtree that contains tree nodes that are database operators or parse nodes. Herein according to the topology of subtrees of a statement, a subtree (i.e. subplan) may be a parent of another subtree. If at least one of those two subtrees is represented by a compiled subplan, then using both subplans requires that the parent subplan have a parameter to identify the child subplan. That is, execution or interpretation of the parent subplan accepts a runtime argument that identifies the child subplan.

For example, a parent subplan, either compiled or not, has a parameter to identify a compiled child subplan. In another example, a compiled parent subplan has a parameter to identify an uncompiled (i.e. interpreted) child subplan. Thus execution of a statement may switch back and forth between interpretation and direct execution.

Herein, the following general purpose compiler optimizations may or may not be based on a parameter as defined above: inlining of subroutines and constants, loop unrolling, constant folding, and dead code elimination. Any of those general purpose optimizations, only if using a parameter, is referred to herein as partial evaluation. Partial evaluation to generate an independently compiled subplan is novel. Here, independently compiled means that the subplan is a compilation unit. A compilation unit is a lexical scope that is not nested within an enclosing lexical scope during compilation.

Herein, partial evaluation occurs during compilation of a subplan. For example, the subplan may have a parameter to identify a database table column, and an argument for that parameter may identify a particular column of a particular database table. The argument identifies column metadata that indicates the particular column can or cannot contain a null value. If the column forbids nulls, a null check is unneeded, and the null check and any of its null handling logic is dead code that can be eliminated by partial evaluation.

In this example as discussed above, the first statement plan for database statement 105 contains the first and third subplans. The first subplan may have compiled subplan 130, and the third portion may be an uncompiled subplan. Those two subplans have respective subtrees that are connected in mixed execution plan 150 shown in FIG. 1.

Any tree node may contain an identifier of a database operator, and herein are three kinds of database operator. A relational operator is a database operator that implements part of a relational algebra, and a relational operator is designed for tabular or columnar data. A parameter operator is a database operator that is a placeholder that, in mixed execution plan 150 generated in execution phase 202, can be replaced by a runtime argument value such as a literal (i.e. constant), a database schema element, or a compiled or uncompiled subplan. An expression operator is a database operator that implements value-based computation such as a filter condition or a join condition. A subtree of expression operators may be a child operator of a relational operator such as filtration or a join.

Control flow between subplans having connected subtrees may depend on various implementation concerns such as which database operators are blocking or non-blocking and which database operators and/or parameters are buffered or unbuffered. Herein, scanning, filtration, projection, and joining may be non-blocking. Herein, sorting and statistic operators such as maximum and average may be blocking. A blocking database operator must receive and process all data (e.g. all rows in a row set) before the operator can provide a result to its parent operator (e.g. some tree node in the parent subplan). Herein, blocking and non-blocking may or may not respectively imply synchronous and asynchronous. In some cases, a buffered database operator must receive and process enough data items (e.g. a multi-row subset of rows in a row set) to fill a memory buffer before the operator can provide the buffer contents to its parent operator (e.g. some tree node in the parent subplan). Herein, unbuffered and buffered may or may not respectively imply synchronous and asynchronous.

Thus in some cases, control flow may switch back and forth between parent subplan and child subplan. In any case, the parent subplan may operate before the child subplan or vice versa. Thus depending on the scenario, the compiled first subplan may execute before the uncompiled third subplan or vice versa. Thus, the ordering of steps 302 and 304 may be reversed in some scenarios. Without generating logic, step 304 interprets the uncompiled third subplan in the first statement plan for database statement 105. Step 302 occurring before step 304 is execution of a compiled subplan before interpretation of an uncompiled subplan. State of the art execution of a compiled statement never switches back to interpretation.

### 4.0 Example Subplan Generation

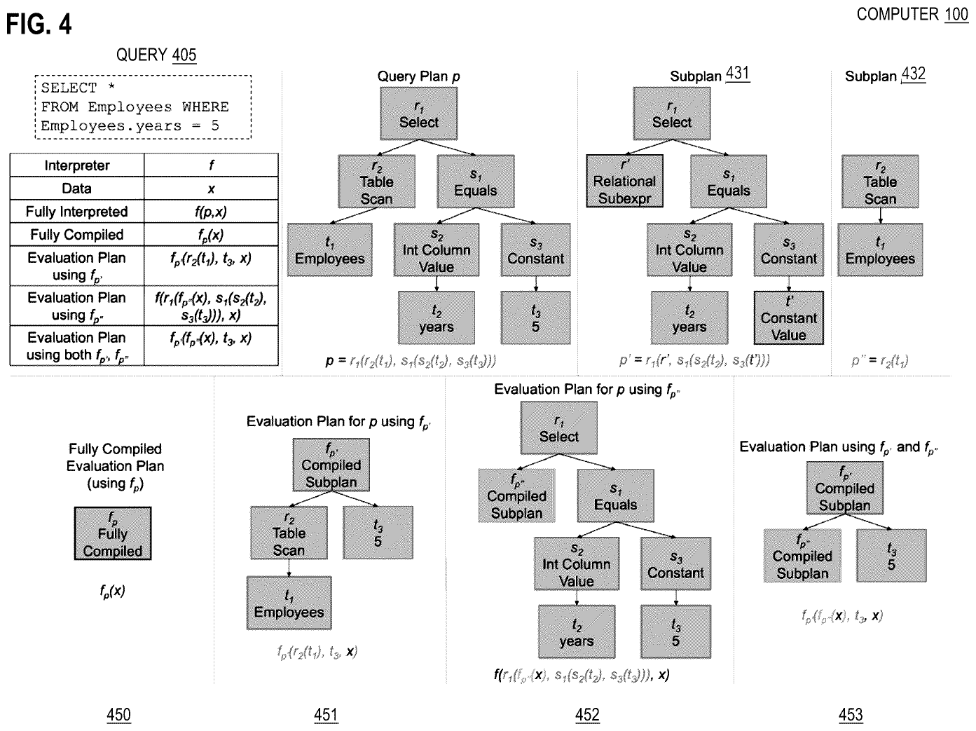

FIG. 4 is a block diagram that depicts example computer 100 that can generate various plans and subplans for query 405. For example, SQL optimizer 110 may generate query plan P that may be decomposed into subplans 431 and 432.

Shown beneath query 405 is a demonstrative legend of the following components in computer 100. Interpreter F is interpreter 240 in FIG. 2. Data X is an argument for a parameter as defined earlier herein, and data X is also referred to as argument X. Herein, query plan P is a whole plan that may be a member of a parameterized cluster. F(P,X) interprets uncompiled query plan P with argument X. If P instead is one of subplans 431 or 432, then F(P,X) interprets the uncompiled subplan with argument X.

FP(X) executes compiled plan or subplan P with argument X. Depending on the context argument X is any comma-separated list of distinct arguments shown in FIG. 4. For example although not shown, F(T1,T2) would have two distinct arguments that may have respective distinct values and/or distinct datatypes.

Herein, a statement's evaluation plan (e.g. mixed execution plan 150 in FIG. 1) is not generated until execution phase 202, and the evaluation plan may contain zero or more compiled subplans and zero or more uncompiled subplans as discussed earlier herein. All of evaluation plans 450-453 contain a compiled portion or whole of query 405. Each of evaluation plans 450-453 is logically equivalent to shown uncompiled query plan P.

FIG. 4 shows various arguments that are relational tables T1-T2 and literal (i.e. constant) T3. Herein, partial evaluation may remove (e.g. inline or dead code eliminate) zero or more parameters of a subplan. For example, fully compiled evaluation plan 450 is not composed of subplans and does not have parameters, which is why arguments T1-T3 are not shown in fully compiled evaluation plan 450.

Evaluation plans 451-453 have parameters only for various subsets of arguments T1-T3. As discussed earlier herein, a child subplan may be an argument of a parent subplan. As shown, subplan 431 has two parameters R′ and T′. As shown, subplan 432 has no parameters.

A compiled subplan that has no parameters can be included in an evaluation plan only as a tree leaf, as shown in evaluation plan 452. In evaluation plan 451, subplan 431 was compiled and has two parameters R′ and T′ whose arguments are the two uncompiled child subtrees of the compiled root node of evaluation plan 451. In evaluation plan 453, both subplans 431 and 432 were compiled, and subplan 431 has two parameters R′ and T′ whose arguments respectively are compiled subplan 432 and an uncompiled literal.

In an embodiment, a subtree (i.e. subplan) is processed by processing all of its tree nodes by recursive descent from the root of the subtree. Herein, multiple parameters of a relational operator (i.e. tree node) or subtree (i.e. subplan) are ordered, even if the relational operator disregards the ordering. Herein, two tree nodes match only if: a) they have identical types, b) their ordered lists of parameters match in count and types, and c) their contained child nodes recursively match. For example, one join operator may match another join operator but does not match a table scan operator.

If two relational operators have a same count of parameters, then unification causes positionally corresponding parameters that do not have identical types to be generalized by a predefined universal type. Any parameter that has the universal type is referred to herein as an unspecialized parameter or a general parameter. An unspecialized parameter is generated only by merging two clusters that disagree on the type of a parameter, and the unspecialized parameter replaces that parameter in the subplan (i.e. subtree) of the cluster. In that way, a merge may replace zero or more parameters.

As discussed earlier herein, a parameter may identify a child node of a relational operator (i.e. tree node). Thus, unification can effectively prune a tree branch off of the relational operator, and replace the branch with an unspecialized parameter. Thus merging may entail pruning a subtree from one or two otherwise identical subtrees. For example, subplan 432 is a branch that was pruned from query plan P.

Herein, a pruned branch may by itself become a new cluster and may, for example, merge with pruned branches of other subtrees. Thus a merge can generate and delete clusters/subplans/subtrees. For example if a subplan generated for a potential merge has sufficient net benefit, the two other subplans being merged are deleted. By agglomeration in set of subplans 220, the merged cluster replaces the two clusters being merged.

In an embodiment, subplan clustering 210 treats subplans as subtrees as discussed earlier herein and initiates clustering by: a) comparing every distinct possible pair of whole plans in set of query plans 200, b) recursively matching subtrees when relational operator types match, and c) pruning and replacing branches with unspecialized parameters as needed to resolve (i.e. unify) parameter type mismatches.

### 4.1 Workload Unification Pseudocode

In an embodiment, subplan clustering 210 can sometimes treat plans and subplans as interchangeable. For example, subplan clustering 210 may invoke the following subtree unification pseudocode with a pair of whole trees (i.e. plans) as below subplans p′and p″.
Input: Two subplans p′ and p″
Output: A set of all possible subplan unifications

| | |
|---|---|
| 1: | procedure ExhaustiveUnify(p′, p″) |
| 2: | ret ← ∅ |
| 3: | for r₁ ∈ p′ where r₁.type is relational operator do |
| 4: | for r₂ ∈ p″ where r₂.type is relational operator do |
| 5: | ret ← ret ∪ Unify(r₁, r₂) |
| 6: | end for |
| 7: | end for |
| 8: | return ret |

For example, the above pseudocode may be invoked for every distinct possible pair of whole plans in set of query plans 200.

### 4.2 Recursive Descent Unification Pseudocode

The above pseudocode invokes the following recursive descent unification pseudocode, where children is an ordered list of parameters.
Input: Two nodes n1 and n2 with n1.type=n2.type, meaning nodes n1 and n2 have the same data type.
Output: A unified node of n₁ and n₂, which may have children and be treated as a tree.

| | |
|---|---|
| 1: | procedure Unify(n₁, n₂) |
| 2: | declare n_{unified} |
| 3: | n_{unified}.type ← n₁.type |
| 4: | if n₁.subtype = n₂.subtype then |
| 5: | n_{unified}.subtype ← n₁.subtype |
| 6: | C_{unified} ← ∅ |
| 7: | for (C₁, C₂) ∈ (n₁.children, n₂.children) do |
| 8: | C_{unified} ← C_{unified} ∪ Unify(C₁, C₂) [symbol] Since n₁ and |

n₂ match subtypes, their parameters (or children) will have the same data types as well.

| | |
|---|---|
| 9: | end for |
| 10: | n_{unified}.children ← C_{unified} |
| 11: | return n_{unified} |
| 12: | else |
| 13: | n_{unified}.subtype ← unspecialized parameter |
| 14: | return n_{unified} |
| 15: | end if |

### 4.3 Iterative Agglomeration

Because of the exhaustive way in which both above pseudocodes cooperate, many alternative potential merges may be proposed, and subplan clustering 210 may select a best of those potential merges that has a highest benefit. Only the best merge occurs, and subplans of less beneficial potential merges are discarded.

In an iterative embodiment, subplan clustering 210 initializes set of subplans 220 with one subplan (i.e. cluster) per whole plan in set of query plans 200 and in each iteration: a) invokes above subtree unification pseudocode for every distinct possible pair of subplans currently in set of subplans 220, b) generates many potential merges for a particular pair of subplans and selects and causes the best merge for that pair of subplans to generate a merged cluster with a merged subplan that may have unspecialized parameters, and c) discard potential merges having insufficient estimated net benefit. In that way, the population of set of subplans 210 may iteratively evolve and improve until a resource budget is exhausted or no potential merges of any pair of subplans currently in set of query plans 200 has sufficient estimated net benefit to merge. Net benefit estimation is discussed later herein.

In a single iteration, subplan clustering 210 may process many pairs of subplan clusters, including one with two subplans p′=r1 (r2 (r3 (t1), s1 (t2, t3))) and p″=r2 (r3 (t4), s1 (t2, t5)). Subplan p′ has three relational operators r1, r2, and r3 while subplan p″ has two relational operators r2 and r3. A portion inside subplan p′ shares some similarity with subplan p″. The above subtree unification pseudocode attempts to find this similarity in the form of a subplan. By treating each of these relational operators as the root of a subplan, then the pseudocode decomposes both given subplans into three subplans in p′ and two subplans p″ for a combination of the following six total example unifications (i.e. potential clusters).
(1) Unify(r1 (r2 (r3 (t1), s1 (t2, t3))), r2 (r3 (t4), s1 (t2, t5)))=r′
(2) Unify(r2 (r3 (t1), s1 (t2, t3), r2 (r3 (t4), s1 (t2, t5)))=r2 (r3 (t′), s1 (t2, t′))
(3) Unify(r3 (t1), r2 (r3 (t4), s1 (t2, t5)))=r′
(4) Unify(r1 (r2 (r3 (t1), s1 (t2, t3))), r3 (t4))=r′
(5) Unify(r2 (r3 (t1), s1 (t2, t3)), r3 (t4))=r′
(6) Unify(r3 (t1), r3 (t4))=r3 (t′)

### 5.0 Example Subplan Clustering

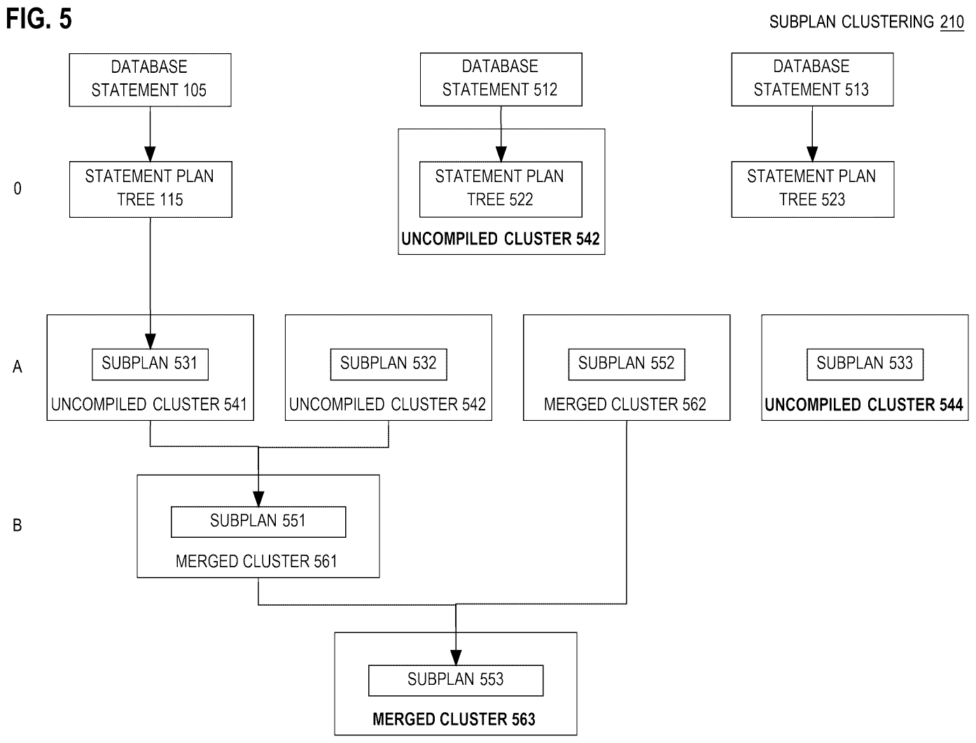

FIG. 5 is a dataflow diagram that depicts example subplan clustering 210 that iteratively generates set of subplans 220 from set of query plans 200 that contains statement plan trees 115 and 522-523 for respective database statements 105 and 512-513. Statement plan tree 115 is shown as optimized query plan 115 in FIGS. 1-2.

Time demonstratively flows downwards from iteration 0 to iteration B as shown. When iteration 0 begins, set of subplans 220 initially contains whole statement plan trees 115 and 522-523, each of which has its own uncompiled cluster. For example, uncompiled cluster 542 represents only statement plan tree 522.

In any iteration, subplan(s) may be created or deleted by merging or created by pruning. Zero or more iterations may occur between iterations 0 and A, iteration A begins with subplans 531-533 and 552 that are represented by uncompiled clusters 541-542, 544, and 562. A merged cluster is an uncompiled cluster that is generated by merging. It does not matter which of subplans 532-533 and 552 originated from subtrees of which of statement tree plans 115 and 522-523.

None of the parameters were already unspecialized when uncompiled clusters 541-542 merge in iteration A to generate merged cluster 561 that may have unspecialized parameter(s). Iteration B may propose two potential merges that are: a) merging merged clusters 561-562 and b) merging clusters 561 and 544. If merging subplan 552 has a higher benefit than merging subplan 533, then merged clusters 561-562 are merged to generate merged cluster 563 in iteration B.

As shown, clusters 541, 542, 561, and 562 are merged and deleted along with their subplans. Clusters 542, 544, and 563 are shown bold to indicate that they are retained after iteration B. If iteration B is the last iteration, then only all or some of clusters 542, 544, and 563 will be compiled.

### 6.0 Example Agglomeration Process

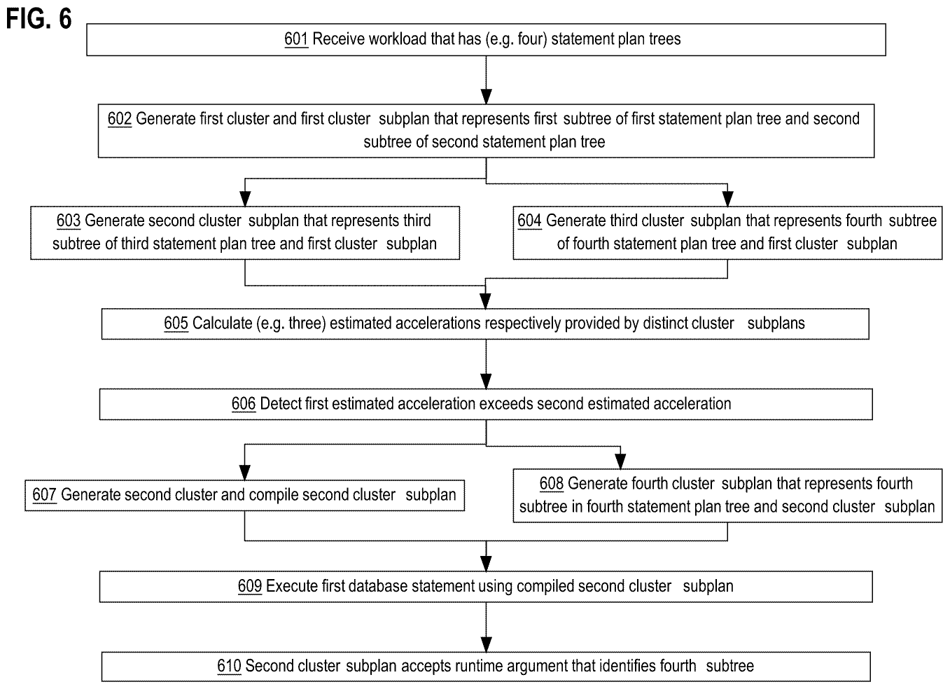

FIG. 6 is a flow diagram that depicts an example process that computer 100 may perform to accelerate execution of database statement 105 by decomposing statement plan tree 115 into a mix of compiled and uncompiled subplans.

Steps 601-608 occur during code generation phase 201 that, in this example, operates subplan clustering 210 as shown in FIG. 5. Steps 609-510 occur during execution phase 202 on a same or different computer.

In this example, step 601 receives set of query plans 200 that is a workload that contains at least four statement plan trees, including statement plan trees 115 and 522-523 as discussed earlier herein. In this example, subplan 531 is a subtree of statement plan tree 115, and subplan 532 is a subtree of statement plan tree 522.

Subplan clustering 210 performs steps 602-608. Step 602 generates in this ordering: a) uncompiled clusters 541-542 and their respective subplans 531-532 and then b) uncompiled merged cluster 561 and its subplan 551 by merging clusters 541-542. As follows, benefit estimation may control ranking and/or rejection of uncompiled clusters.

Subplan clustering 210 performs agglomeration to generate and merge clusters as shown in FIGS. 5-6. As discussed later herein, subplan clustering 210 generates a new cluster by opportunistically merging two existing clusters. Identical clusters have identical parameters. The net benefit of merging identical clusters is never negative. For example, subplans 531-532 may be identical and merged in iteration A by step 602.

Step 603 proposes merging clusters 561-562 and generates subplan 553. Step 604 instead proposes merging clusters 544 and 561 and generates a corresponding subplan. Steps 603-604 may concurrently occur or either step may occur before the other.

Step 605 estimates an acceleration (i.e. benefit) respectively provided by each of the subplans proposed by steps 603-604. Estimations of uncosted benefit and net benefit are discussed later herein.

Step 606 detects that the estimated acceleration from step 603′s proposed subplan 553 exceeds the estimated acceleration from step 604′s proposed subplan (not shown). In that case: subplan 553 is retained; the other proposed subplan will not be compiled and is discarded; and step 607 generates merged cluster 563.

In a same or later iteration and although cluster 544 was not selected for merging by step 607, step 608 may for example merge cluster 544 with any other shown or unshown cluster. Any two uncompiled clusters can potentially merge, but not if an estimated net benefit of the merge is negative. Only uncompiled clusters can merge. In various embodiments, during or after iteration, subplan clustering 210 ensures that set of subplans 220 contains only uncompiled clusters whose net benefit exceeds a relative (e.g. ranking) or absolute threshold.

In an embodiment, subplan clustering 210 finishes all merging before native compiler 120 compiles only all or better ranking or sufficiently net-beneficial clusters. For example, clusters 542, 544, and 563 are shown bold to indicate that they are finally selected to be compiled by native compiler 120. A cluster is compiled by compiling its subplan.

In execution phase 202, step 609 executes database statement 105 using compiled subplan 553 that is derived from merged clusters 561-562, which are derived from two or more of database statements 105 and 512-513. For example if subplans 531-532 and 552 are respectively derived from statement plan trees 115 and 522-523, then compiled subplan 553 may be reused to individually accelerate each of database statements 105 and 512-513.

As discussed earlier herein, matching compiled subplans 230 may generate an evaluation plan (e.g. mixed execution plan 150 in FIG. 1) that represents optimized query plan 115 as a composite of compiled and uncompiled subplans. If a subplan is a binary tree of relational operators, then every subplan of the composite evaluation plan has zero, one, or two parameters to identify child subplans. For example, a compiled or uncompiled parent subplan of an executing statement may accept a runtime argument that identifies a compiled or uncompiled child subplan in step 610.

### 7.0 Example Net Benefit Estimation

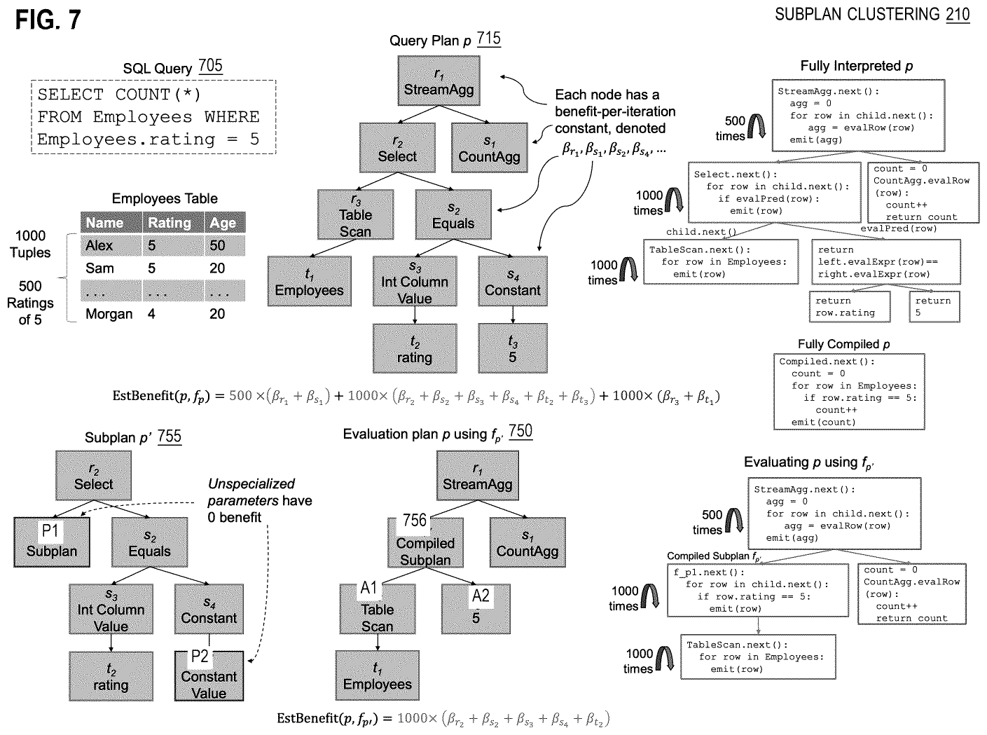

FIG. 7 is a block diagram that depicts example subplan clustering 210 that can generate various plans and subplans for SQL query 705 that is represented by query plan 715 during either or both compilation and execution phases. Plans 715 and 750 are logically equivalent. During code generation phase 201, subplan clustering 210 generates uncompiled subplan 755 that native compiler 120 compiles to generate compiled subplan 756. During execution phase 202, matching compiled subplans 230 may generate evaluation plan 750 that contains compiled subplan 756.

Uncompiled subplan 755 has only two parameters P1-P2, each of which has a respective one of runtime arguments A1-A2 in evaluation plan 750. When compiled subplan 756 accepts argument A1 in evaluation plan 750, a table scan of the Employees table occurs. In a different evaluation plan, if compiled subplan 756 instead accepts a different argument value for same parameter P1, then a different table is scanned or a different relational operator acts instead of a table scan.

A statement may have two distinct tree nodes X-Y (not shown) to scan two tables. Tree nodes X-Y may each have a reference to a single table scan relational operator that is shared by both tree nodes X-Y, but with different argument values. Each distinct relational operator may have its own predefined non-negative estimated unit benefit of compilation that is shown in FIG. 7 as “a benefit-per-iteration”. For example, the estimated unit benefit of a computationally-intensive relational operator such as a join operator may be higher than an input/output (I/O) intensive relational operator such as a table scan operator.

In that case, tree nodes X-Y have a same estimated unit benefit because tree nodes X-Y share a same relational operator. However, tree node X may scan a table that contains ten times as many table rows as tree node Y scans. In that case, the estimated multirow benefit of compilation of tree node X may be higher even though tree nodes X-Y have the same unit benefit. FIG. 7 shows that the Employee table has 1,000 rows, 500 of which have a rating of five. Here, 500 is a row count that depends on table cardinality and column selectivity. Here, 1,000 is a row count that depends only on table cardinality.

As shown by the horseshoe arrows, each relational operator tree node may have a respective row count that, when multiplied by the estimated unit benefit of the relational operator, provides an estimated multirow benefit of compiling the tree node. The uncosted benefit of compiling a subplan (i.e. subtree) is the sum of estimated multirow benefits of all relational operator tree nodes in the subtree.

An uncompiled subtree has zero benefit and zero compilation cost. The estimated net benefit of compiling a subplan is the uncosted benefit of the subplan minus the compilation cost of the subplan. In an embodiment, there is only one predefined universal compilation cost that compilation of any subplan incurs. If the compilation cost exceeds the uncosted benefit of the subplan, then the net benefit of the subplan is negative, and the subplan will not be compiled. That is, the compilation cost may operate as a compilation threshold.

### 8.0 Example Net-Benefit Estimation Process

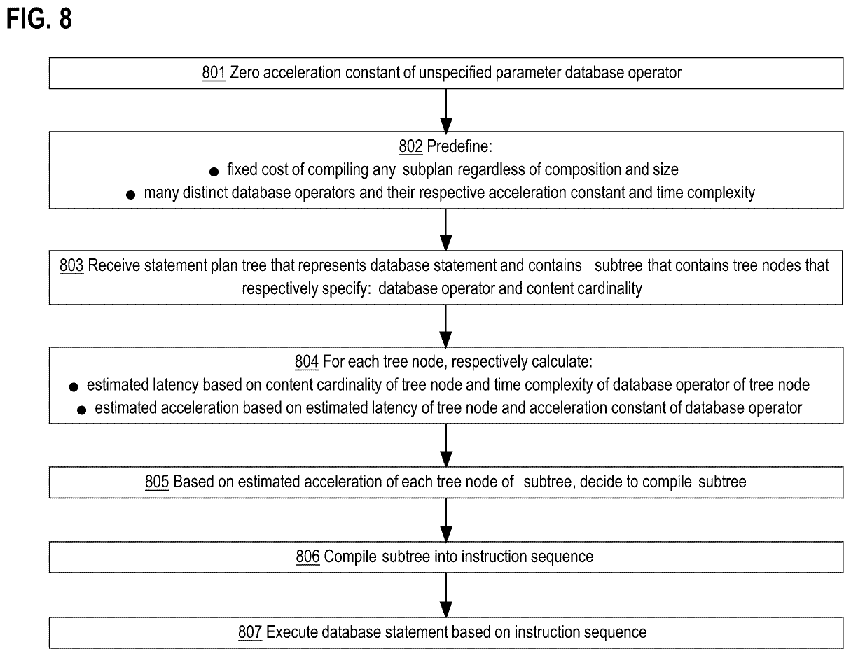

FIG. 8 is a flow diagram that depicts an example process that computer 100 may perform to accelerate execution of SQL query 705 by decomposing query plan 715 into a mix of compiled and uncompiled subplans. Steps 801-802 are preparatory and occur before code generation phase 201. Steps 803-806 occur in code generation phase 201. Step 807 occurs in execution phase 202 on a same or different computer.

As discussed earlier herein, any tree node may contain an identifier of a database operator, and three kinds of database operator are relational operator, expression operator, and parameter operator such as unspecified parameter operator. Herein, compilation of a tree node that refers to a relational operator provides acceleration whose magnitude depends on which kind of relational operator. Herein, a database operator is a singleton that may be shared (i.e. referenced) by many tree nodes in many whole or partial plans.

Acceleration herein is provided by subplan compilation. No acceleration is provided by interpretation of a subplan nor use of an unspecified parameter that can accept, for example, an uncompiled (i.e. interpreted) subplan as a runtime argument. For that reason, step 801 zeros an acceleration constant of the unspecified parameter operator.

Step 802 predefines a) a fixed cost of compiling any subplan regardless of the composition and size of the subplan and b) many distinct relational operators and their respective non-negative acceleration constant and time complexity. An acceleration constant is referred to earlier herein as an estimated unit benefit of compilation. For example, the acceleration constant of a computationally-intensive relational operator such as a join operator may be higher than an input/output (I/O) intensive relational operator such as a table scan operator. In an embodiment, most relational operators have linear time complexity, such as a table scan operator. In an embodiment for n tuples, a sort operator has a time complexity of O (n log(n)) that is slower than linear, and an index scan operator has a time complexity of O (log(n)) that is faster than linear. Acceleration constants and time complexities of relational operators are predefined because they do not depend on statements, plans, subtrees, nor tree nodes.

Subplan clustering 210 performs steps 803-805. Step 803 receives set of query plans 200 that contains query plan 715, referred to herein as statement plan tree 715, that represents SQL query 705. Statement plan tree 715 contains a subtree that contains tree nodes that respectively specify a relational operator and a content cardinality. Herein, content cardinality is a (e.g. estimated) non-negative count of rows in a row set that the relational operator is expected to process for the statement. In an embodiment, SQL optimizer 110 provides, by estimation, the content cardinality of each tree node in statement plan tree 715. For example, SQL optimizer 110 may randomly sample a small subset of values in a database column to estimate a selectivity, a number of distinct values (NDV), and/or a content cardinality.

In an embodiment, content cardinality instead is empirically observed and recorded by a previous execution of: a) SQL query 705 or b) a compiled subplan that is based on a respective subtree of statement plan tree 715 and another statement plan tree of another statement. For example, the lifecycle of the workload may entail in this ordering: a) a first compilation phase with inaccurately estimated cardinalities, b) a slightly accelerated first execution phase that records empirically observed cardinalities, c) a second compilation phase with accurate observed cardinalities, and d) a second highly accelerated second execution phase with more or less the same workload.

For each tree node, step 804 respectively calculates: a) an estimated latency based on content cardinality of a tree node and time complexity of the relational operator of the tree node and b) an estimated acceleration based on the estimated latency of the tree node and the acceleration constant of the relational operator. Here, (b) is referred to earlier herein as an estimated multirow benefit of compilation. Based on the estimated acceleration, (b), of each tree node of a subtree of statement plan tree 715, step 805 decides to compile the subtree and/or merge the subtree into a cluster.

Into compiled subplans 250 in step 806, native compiler 120 compiles the subtree (or the cluster into which it merged) into a machine instruction sequence that computer 100 can directly (i.e. natively) execute for acceleration.

In execution phase 202, matching compiled subplans 230 performs step 807 that detects that, in compiled subplans 250, statement plan tree 715 already has compiled subplan(s) that each has a respective machine instruction sequence, including the subtree compiled by previous step 806. As discussed earlier herein, step 807 generates an evaluation plan that is logically equivalent to statement plan tree 715. The evaluation plan consists of one or more compiled subplans, including the subplan compiled by previous step 806, and zero or more uncompiled (i.e. interpreted) subplans. Step 807 executes SQL query 705 by applying the evaluation plan by interpreting the evaluation plan's uncompiled subplans and, for acceleration, directly executing the instruction sequences of the evaluation plan's compiled subplans, including the subplan compiled by previous step 806. Step 807 is faster than interpreting all of statement plan tree 715.

Because a compiled subplan has zero or more parameters, the instruction sequence of the subplan accepts (e.g. in processor registers or on a call stack in RAM) zero or more runtime arguments respectively for the parameters. As discussed earlier herein, a subplan may contain a subtree that consists of tree nodes that refer to expression operators that may be mathematical, statistical, or logical operators. For example, the subtree may represent a query WHERE filtration clause that is a compound expression represented by multiple expression operators and literal constants. In code generation phase 201, an embodiment may unconditionally (i.e. without cost-benefit estimation) compile all expression operators into stack instructions of an instruction set architecture (ISA) of a stack machine that is not the native ISA of computer 100. For example, the stack machine may be a virtual machine. The ISA of the stack machine lacks registers, and the stack instructions do not identify registers. For example, computer 100 may delegate (i.e. offload) the execution of the stack instructions to a disk storage server that is external to computer 100 to perform a so-called smart scan.

### 8.1 Example Optimal Iteration and Example Best Pair of Clusters to Merge

Subplan clustering 210 may be iterative as discussed earlier herein. Each iteration may have a sequence of two distinct selection phases. Both phases are dynamic as follows. The first phase selects which pair of clusters are best to merge. However, each cluster in the pair usually has multiple distinct branches that are pruning alternatives, and the second phase selects which respective branch(es) are best to prune and replace with unspecialized parameters. Thus, the second phase selects the best merge of multiple distinct possible ways to merge the best pair of clusters that the first phase selected.

In an embodiment, subplan clustering 210 is implemented by multiple interdependent pseudocodes, including most or all pseudocodes herein. In an embodiment, the first selection phase is implemented by the following optimally iterative pseudocode that discovers (i.e. dynamically selects) a best possible pair of any two clusters that are opportunistically selected according to an inter-cluster distance metric discussed later herein.
Input: A set P={p1, p2, . . . , pn} of n query plans and a cost of compilation, denoted as y.
Output: A set of subplan clusters.

| | |
|---|---|
| 1: | procedure SubplanClustering(Query plan set P , Cost γ ) |
| 2: | C ← {c₁, c₂, . . . , cₙ } for each pᵢ ∈ P, cᵢ .plan ← pi and |

cᵢ .Q + {pi } [symbol] Clusters are initialized for each query plan, which can evaluate themselves.

| | |
|---|---|
| 3: | Compute matrix M where Mi,j = Distance(cᵢ , c j). |
| 4: | while (min(Mi,j ∈ M) ≤ γ ) ∧ (\|C \| ≥ 2) do |
| 5: | Find cᵢ , c j ∈ C with min(Mi,j ∈ M) |
| 6: | cmerged ← CreateMergedCluster(cᵢ , c j ) |
| 7: | C ← C ∪ {c_{merged}} \ {cᵢ , c j } |
| 8: | C ← C ∪ CreateDifferenceClusters(cᵢ , c_{merged}) ∪ |

CreateDifferenceClusters(cj , c_{merged})

| | |
|---|---|
| 9: | Update matrix M |
| 10: | end while |
| 11: | return C′ ⊆ C where ∀c ∈ C′, TotalBenefit(c) > Cost |

Lines 4-10 in the above optimally iterative pseudocode is a control flow loop. Each iteration of that loop may be any of iterations 0 and A-B in FIG. 5. Each iteration merges two existing clusters into one new cluster.

As discussed later herein, Distance( ) is invoked by line 3 to measure a distance between two clusters, for all possible pairs of clusters. In line 4, min( ) are the two clusters that are nearest (i.e. least distance) to each other, which is the best possible pair of clusters to merge in a current iteration.

Agglomeration iteration ceases upon convergence that is when the condition in line 4 is satisfied (i.e. true), which usually is when many possible merges remain, but none have sufficient net benefit. In another scenario, there is no other cluster to merge with a sole remaining cluster. In either case, iteration ceases.

### 8.2 Example Best Way to Merge Two Clusters

The second selection phase may be implemented by the following two example pseudocodes. The following is an example best merge pseudocode that may implement the second selection phase that a) discovers many possible ways to merge a given best pair of clusters and b) selects the best merge in which the potential merged cluster has a subplan with the highest uncosted benefit of compiling as discussed earlier herein.

| 14: | procedure CreateMergedCluster(Clusters c₁, c₂) |
|---|---|
| 15: | S ← Exhaustive Unify(c₁.plan, c₂.plan)) |
| 16: | c_{merged}.Q ← c₁ .Q ∪ c₂ .Q [symbol] This set |
| union does not remove duplicate query plans. | |
| 17: | c_{merged}.plan ← argmax EstBenefit(q, ƒ cᵢ .plan) |
| [symbol] Choose the unification with highest benefit. | |
| 18: | return c_{merged} |

The following is an example branch pruning pseudocode for a given best way to merge a given best pair of clusters.

| | |
|---|---|
| 26: | procedure CreateDifferenceClusters(Clusters c, c_{merged}) |
| 27: | p ← c.plan, p_{merged} ← c_{merged}.plan |
| 28: | if p_{merged}.subtype ≠ unspecialized parameter then [symbol] This conditional check prevents an |

infinite loop of adding back difference clusters indefinitely.

| | |
|---|---|
| 29: | P_{diff} ← Δ(p, p_{merged}) |
| 30: | return {c₁, c₂, . . . , C \|P_{diff} \| } for each pi ∈ P_{diff}, cᵢ .plan ← |

pᵢ and cᵢ .Q ← c.Q

| | |
|---|---|
| 31: | else |
| 32: | return ∅ |
| 33: | end if |

### 8.3 Novel Inter-Cluster Distance Metric

As discussed above, both selection phases of an iteration have a respective distinct metric to optimize. The second selection phase maximizes the uncosted benefit of compiling a subplan of the merged cluster. The first selection phase is agglomerative and instead minimizes inter-cluster distance that is measured as follows. Herein, novel distance between a pair of two clusters is the subtractive difference between: a) their combined uncosted benefits of both subplans being separately compiled without merging and b) the uncosted benefit of compiling the potential merged cluster of the pair. This distance is never negative because separate compilations always provide the most specialization (i.e. opportunities for partial evaluation) and thus the most acceleration of execution. The following example pseudocode is an example measurement of novel inter-cluster distance.

| 21: | procedure Distance(Clusters c₁, c₂) | [symbol] This is performance |
|---|---|---|
| | | benefit loss. |
| 22: | c_{merged} ← CreateMergedCluster(c₁, c₂) | |
| 23: | return TotalBenefit(c₁) + | TotalBenefit(c₂) − |

TotalBenefit(c_{merged})

### 9.0 Database System Overview

A database management system (DBMS) manages one or more databases. A DBMS may comprise one or more database servers. A database comprises database data and a database dictionary that are stored on a persistent memory mechanism, such as a set of hard disks. Database data may be stored in one or more data containers. Each container contains records. The data within each record is organized into one or more fields. In relational DBMSs, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement that conforms to a database language. A database language for expressing the database commands is the Structured Query Language (SQL). There are many different versions of SQL, some versions are standard and some proprietary, and there are a variety of extensions. Data definition language (“DDL”) commands are issued to a database server to create or configure database objects, such as tables, views, or complex data types. SQL/XML is a common extension of SQL used when manipulating XML data in an object-relational database.

A multi-node database management system is made up of interconnected nodes that share access to the same database or databases. Typically, the nodes are interconnected via a network and share access, in varying degrees, to shared storage, e.g. shared access to a set of disk drives and data blocks stored thereon. The varying degrees of shared access between the nodes may include shared nothing, shared everything, exclusive access to database partitions by node, or some combination thereof. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

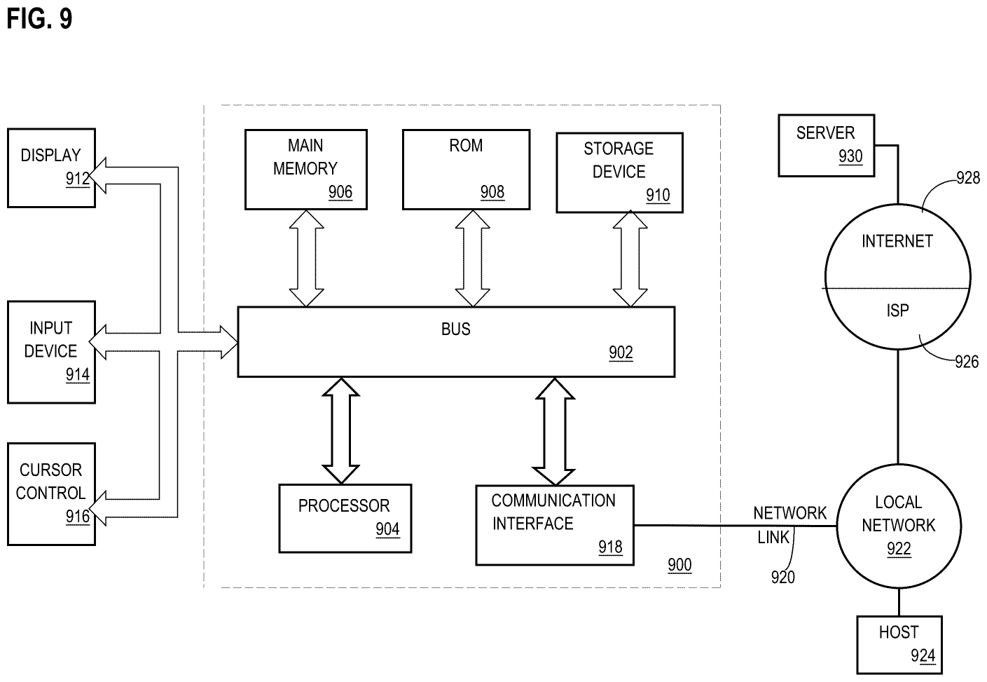

For example, FIG. 9 is a block diagram that illustrates a computer system 900 upon which an embodiment of the invention may be implemented. Computer system 900 includes a bus 902 or other communication mechanism for communicating information, and a hardware processor 904 coupled with bus 902 for processing information. Hardware processor 904 may be, for example, a general purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 910. Volatile media includes dynamic memory, such as main memory 906. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

### Software Overview

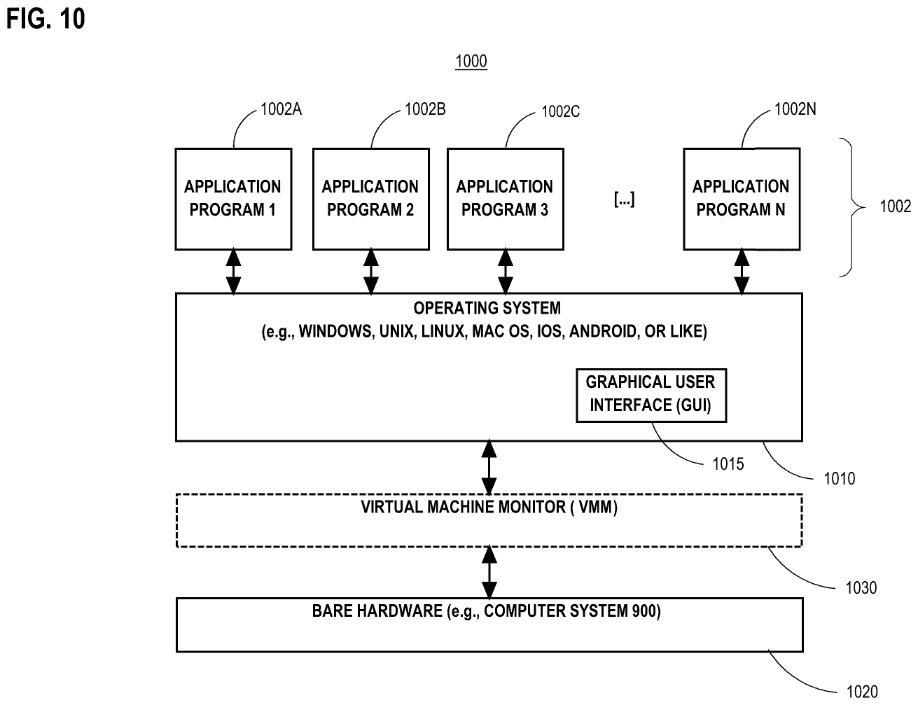

FIG. 10 is a block diagram of a basic software system 1000 that may be employed for controlling the operation of computing system 900. Software system 1000 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1000 is provided for directing the operation of computing system 900. Software system 1000, which may be stored in system memory (RAM) 906 and on fixed storage (e.g., hard disk or flash memory) 910, includes a kernel or operating system (OS) 1010.

The OS 1010 manages low-level aspects of computer operation, including managing execution of processes, memory allocation, file input and output (I/O), and device I/O. One or more application programs, represented as 1002A, 1002B, 1002C . . . 1002N, may be “loaded” (e.g., transferred from fixed storage 910 into memory 906) for execution by the system 1000. The applications or other software intended for use on computer system 900 may also be stored as a set of downloadable computer-executable instructions, for example, for downloading and installation from an Internet location (e.g., a Web server, an app store, or other online service).

Software system 1000 includes a graphical user interface (GUI) 1015, for receiving user commands and data in a graphical (e.g., “point-and-click” or “touch gesture”) fashion. These inputs, in turn, may be acted upon by the system 1000 in accordance with instructions from operating system 1010 and/or application(s) 1002. The GUI 1015 also serves to display the results of operation from the OS 1010 and application(s) 1002, whereupon the user may supply additional inputs or terminate the session (e.g., log off).

OS 1010 can execute directly on the bare hardware 1020 (e.g., processor(s) 904) of computer system 900. Alternatively, a hypervisor or virtual machine monitor (VMM) 1030 may be interposed between the bare hardware 1020 and the OS 1010. In this configuration, VMM 1030 acts as a software “cushion” or virtualization layer between the OS 1010 and the bare hardware 1020 of the computer system 900.

VMM 1030 instantiates and runs one or more virtual machine instances (“guest machines”). Each guest machine comprises a “guest” operating system, such as OS 1010, and one or more applications, such as application(s) 1002, designed to execute on the guest operating system. The VMM 1030 presents the guest operating systems with a virtual operating platform and manages the execution of the guest operating systems.

In some instances, the VMM 1030 may allow a guest operating system to run as if it is running on the bare hardware 1020 of computer system 1000 directly. In these instances, the same version of the guest operating system configured to execute on the bare hardware 1020 directly may also execute on VMM 1030 without modification or reconfiguration. In other words, VMM 1030 may provide full hardware and CPU virtualization to a guest operating system in some instances.

In other instances, a guest operating system may be specially designed or configured to execute on VMM 1030 for efficiency. In these instances, the guest operating system is “aware” that it executes on a virtual machine monitor. In other words, VMM 1030 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating, for an instruction set architecture (ISA) of a processor, an instruction sequence that can execute a first subplan in a statement plan for a database statement; and
executing the database statement by:
invoking the instruction sequence to execute the first subplan in the statement plan, and
interpreting, without generating logic, a second subplan in the statement plan.

2. The method of claim 1 further comprising the instruction sequence accepting a runtime argument that identifies at least one selected from a group consisting of:
a database table,
a table column,
a representation of the second subplan in the statement plan,
a second instruction sequence for the ISA that can execute the second subplan in the statement plan, and
logic for a second ISA that lacks registers.

3. The method of claim 1 wherein:
said executing the database statement comprises the instruction sequence accepting, as a runtime argument, a first database operator that does not access a database table;
the method further comprises after said executing the database statement, the instruction sequence accepting, as said runtime argument, a second database operator that accesses a database table.

4. The method of claim 1 wherein said invoking the instruction sequence causes said interpreting.

5. The method of claim 1 wherein:
the instruction sequence can execute a third subplan in a second statement plan for a second database statement;
said generating is based on the first subplan and the third subplan.

6. The method of claim 1 wherein said invoking the instruction sequence occurs before said interpreting the second subplan.

7. A method comprising:
receiving a plurality of statement plan trees, wherein:
a) each statement plan tree of the plurality of statement plan trees represents a distinct database statement,
b) each statement plan tree of the plurality of statement plan trees contains a distinct plurality of tree nodes,
c) the plurality of statement plan trees contains: a first statement plan tree that contains a first subtree, a second statement plan tree that contains a second subtree, and a third statement plan tree that contains a third subtree, and
d) the first statement plan tree represents a first database statement;
generating a first cluster subplan that represents the first subtree of the first statement plan tree and the second subtree of the second statement plan tree;
generating a second cluster subplan that represents the third subtree of the third statement plan tree and the first cluster subplan; and
executing the first database statement based on the second cluster subplan.

8. The method of claim 7 wherein:
the plurality of statement plan trees contains a fourth statement plan tree that contains a fourth subtree;
the method further comprises:
calculating:
a first estimated acceleration provided by the second cluster subplan and
a second estimated acceleration provided by a third cluster subplan that represents the fourth subtree of the fourth statement plan tree and the first cluster subplan;
compiling the second cluster subplan in response to the first estimated acceleration exceeding the second estimated acceleration.

9. The method of claim 8 further comprising:
calculating a third estimated acceleration provided by a fourth cluster subplan that represents the fourth subtree in the fourth statement plan tree and the second cluster subplan;
detecting that a compilation cost exceeds the third estimated acceleration.

10. The method of claim 7 wherein:
the first subtree contains a fourth subtree;
said executing the first database statement comprises the second cluster subplan accepting a runtime argument that identifies the fourth subtree.

11. A method comprising:
predefining a plurality of distinct database operators, wherein each database operator of the plurality of distinct database operators respectively has an acceleration constant and a time complexity;
receiving a statement plan tree that represents a database statement, wherein:
the statement plan tree contains a subtree that contains a plurality of tree nodes, and
each tree node of the subtree respectively specifies a database operator of the plurality of distinct database operators and a content cardinality;
calculating respectively for each tree node of the subtree:
a) an estimated latency based on the content cardinality of the tree node and the time complexity of the database operator of the tree node and
b) an estimated acceleration based on the estimated latency of the tree node and the acceleration constant of the database operator of the tree node;
deciding, based on the estimated acceleration of each tree node of the subtree, to compile the subtree;
compiling the subtree into an instruction sequence; and
executing the database statement based on the instruction sequence.

12. The method of claim 11 wherein said deciding to compile the subtree is based on an estimated cost selected from a group consisting of:
a) a cost that does not depend on a count of the plurality of tree nodes and
b) a fixed cost that does not depend on at least one selected from a group consisting of the statement plan tree and the subtree.

13. The method of claim 11 wherein:
the plurality of distinct database operators comprises a database operator that represents an unspecified parameter;
said predefining the acceleration constant of the unspecified parameter comprises zeroing the acceleration constant.

14. The method of claim 11 wherein the content cardinality of a particular tree node in the subtree is provided by one selected from a group consisting of:
a) a query optimizer that generated the statement plan tree and
b) a previous execution of one selected from a group consisting of the database statement and the subtree.

15. One or more non-transitory computer-readable media storing instructions that, when executed by one or more processors, cause:
generating, for an instruction set architecture (ISA) of a processor, an instruction sequence that can execute a first subplan in a statement plan for a database statement; and
executing the database statement by:
invoking the instruction sequence to execute the first subplan in the statement plan, and
interpreting, without generating logic, a second subplan in the statement plan.

16. The one or more non-transitory computer-readable media of claim 15 wherein said instructions further cause said instruction sequence accepting a runtime argument that identifies at least one selected from a group consisting of:
a database table,
a table column,
a representation of the second subplan in the statement plan,
a second instruction sequence for the ISA that can execute the second subplan in the statement plan, and
logic for a second ISA that lacks registers.

17. The one or more non-transitory computer-readable media of claim 15 wherein:
said executing the database statement comprises the instruction sequence accepting, as a runtime argument, a first database operator that does not access a database table;
said instructions further cause after said executing the database statement, the instruction sequence accepting, as said runtime argument, a second database operator that accesses a database table.

18. One or more non-transitory computer-readable media storing instructions that, when executed by one or more processors, cause:
receiving a plurality of statement plan trees, wherein:
a) each statement plan tree of the plurality of statement plan trees represents a distinct database statement,
b) each statement plan tree of the plurality of statement plan trees contains a distinct plurality of tree nodes,
c) the plurality of statement plan trees contains: a first statement plan tree that contains a first subtree, a second statement plan tree that contains a second subtree, and a third statement plan tree that contains a third subtree, and
d) the first statement plan tree represents a first database statement;
generating a first cluster subplan that represents the first subtree of the first statement plan tree and the second subtree of the second statement plan tree;
generating a second cluster subplan that represents the third subtree of the third statement plan tree and the first cluster subplan; and
executing the first database statement based on the second cluster subplan.

19. The one or more non-transitory computer-readable media of claim 18 wherein:
the plurality of statement plan trees contains a fourth statement plan tree that contains a fourth subtree;
said instructions further cause:
calculating:
a first estimated acceleration provided by the second cluster subplan and
a second estimated acceleration provided by a third cluster subplan that represents the fourth subtree of the fourth statement plan tree and the first cluster subplan;
compiling the second cluster subplan in response to the first estimated acceleration exceeding the second estimated acceleration.

20. The one or more non-transitory computer-readable media of claim 18 wherein:
the first subtree contains a fourth subtree;
said executing the first database statement comprises the second cluster subplan accepting a runtime argument that identifies the fourth subtree.

21. One or more non-transitory computer-readable media storing instructions that, when executed by one or more processors, cause:
predefining a plurality of distinct database operators, wherein each database operator of the plurality of distinct database operators respectively has an acceleration constant and a time complexity;
receiving a statement plan tree that represents a database statement, wherein:
the statement plan tree contains a subtree that contains a plurality of tree nodes, and
each tree node of the subtree respectively specifies a database operator of the plurality of distinct database operators and a content cardinality;
calculating respectively for each tree node of the subtree:
a) an estimated latency based on the content cardinality of the tree node and the time complexity of the database operator of the tree node and
b) an estimated acceleration based on the estimated latency of the tree node and the acceleration constant of the database operator of the tree node;
deciding, based on the estimated acceleration of each tree node of the subtree, to compile the subtree;
compiling the subtree into an instruction sequence; and
executing the database statement based on the instruction sequence.

22. The one or more non-transitory computer-readable media of claim 21 wherein said deciding to compile the subtree is based on an estimated cost selected from a group consisting of:
a) a cost that does not depend on a count of the plurality of tree nodes and
b) a fixed cost that does not depend on at least one selected from a group consisting of the statement plan tree and the subtree.
